(19) United States
(12) Patent Application Publication
(10) Pub. No.: US 2024/0246029 A1
(43) Pub. Date: Jul. 25, 2024

(54) DECENTRALIZED CARBON NEGATIVE ELECTRICITY GENERATION ON DEMAND WITH NO AIR AND WATER POLLUTION

(71) Applicant: Prakashkumar Narasimhamurthy, London (GB)

(72) Inventor: Prakashkumar Narasimhamurthy, London (GB)

(21) Appl. No.: 18/562,382

(22) PCT Filed: May 19, 2022
(86) PCT No.: PCT/EP2022/063624

§ 371 Date: Nov. 20, 2023

(30) Foreign Application Priority Data
May 21, 2021 (GB) 2107337.4

(51) Int. Cl. B01D 53/62; B01D 53/78; B01D 53/96; C01B 5/00; C01B 32/50; C25B 1/04; C25B 5/00

(52) U.S. Cl. CPC B01D 53/62; B01D 53/78; B01D 53/96; C01B 5/00; C01B 32/50; C25B 1/04; C25B 5/00; B01D 2251/40; B01D 2257/504; B01D 2258/0283

(57) ABSTRACT

This method pertains to mineral carbonization with the objectives of conserving water, decreasing the expenses associated with CO2 capture and permanent sequestration, generating carbon-negative electricity on-demand, and producing weathered aggregates, all while mitigating air and water pollution. The method primarily involves the recirculation of treated ‘second solution’ to create a ‘first solution,’ and the utilization of a ‘third solution’ in an electrolysis process to generate hydrogen and oxygen.

### BACKGROUND OF THE INVENTION

### Field of Invention

This invention pertains to a method for wet mineral carbonization, aimed at conserving water resources, reducing the cost associated with CO₂ capture and permanent sequestration, and generating decentralized carbon-negative electricity on demand. It also addresses the prevention of air and water pollution through the enhancement of both water and energy efficiency within a novel wet mineral carbonization process method. Additionally, this invention involves the integration of the aforementioned novel wet carbonization process method with other processes to produce green hydrogen (H₂), achieve food and beverage-grade (F&B grade) CO₂ production, manufacture weathered/mineral carbonization processed alkaline mineral (AM) aggregates, and generate decentralized carbon negative electricity, on-demand.

### Description of the Related Art

PCT/CA2015/050118 and CA2734540C both describe methods for wet mineral carbonization. However, neither of these methods, the former nor the latter, encompasses the technique for carbon capture and permanent sequestration as disclosed in this innovative wet mineral carbonization method. Moreover, they do not outline integration with the process of producing food and beverage (F&B) grade CO₂ without relying on carbon-intensive energy sources. U.S. 60/921,598 outlines a renewable energy system designed for hydrogen production and carbon dioxide capture. This system introduces an electro-chemical method for removing carbon dioxide from gas streams while simultaneously generating hydrogen gas. Nevertheless, it does not present integration with wet mineral carbonization or a combustion process intended for the capture and permanent sequestration of CO₂. Furthermore, it does not address the process of producing F&B grade CO₂ without relying on carbon-intensive energy sources. Additionally, it does not touch upon the supply of surplus electricity to the grid or the weathering/mineral carbonization processing of alkaline mineral (AM) aggregates. The disclosed novel method of wet mineral carbonization significantly reduces the cost of capturing CO₂, conserving valuable water and energy resources, and effectively mitigating both air and water pollution. Furthermore, it achieves additional cost reductions by generating multiple value-added products through integration with the disclosed novel method of wet mineral carbonization.

### SUMMARY OF THE INVENTION

Capturing and permanently sequestering CO2, conserving water, saving energy, and mitigating air and water pollution are critical priorities aimed at preserving our planet's resources for both current and future generations. Implementing wet mineral carbonization on an industrial scale, coupled with renewable energy utilization and carbon-negative electricity generation, presents an economically viable solution to urgently tackle these pressing global challenges.

Wet mineral carbonization represents an economically viable approach for CO₂ capture and permanent sequestration. This process operates at lower temperatures when compared to dry mineral carbonization, and the ready availability of CO₂ absorbing alkaline minerals (AM), obtained from mined minerals and industrial waste, further enhances its economic feasibility. However, there are limited initiatives in the field of CO₂ capture, utilization, and storage (CCUS) focused on developing a commercially scalable wet mineral carbonization method. In line with a report published by the IPCC, the most promising technology in this domain has reached a technology readiness level of 7-8; nevertheless, it still consumes a significant amount of water, approximately 2 tons per ton of CO₂-absorbing AM. Reducing water consumption, particularly in regions where the supply of fresh and clean water is in high demand, is crucial for ensuring the sustainability and feasibility of this process in such contexts.

In the IPCC case study, wet mineral carbonization was achieved using a stirred tank reactor and a batch process. The process involved stirring a mixture of water and minerals while injecting CO₂ into the stirred tank. In this method, the leachate, which surrounds the mineral particles, remains in the reactor throughout the process. Typically, the leachate has a higher pH, which can hinder the dissolution of injected CO₂ into the minerals. This may be one of the factors contributing to the significant reduction in the CO₂ dissolution rate, as reported in the case study. Therefore, a potential improvement in the dissolution of CO₂ into the minerals could be achieved by continuously removing the higher pH leachate from the reactor and replacing it with a fresh solution having a lower pH, while maintaining this lower pH solution at a constant temperature.

The IPCC report highlights that the wet mineral carbonization process is currently in the research phase and faces three significant challenges to become cost-effective and a viable option for carbon permanent sequestration: (i) Accelerating the overall rate of the process, which may be constrained by the dissolution rate of the metal oxide-bearing material. (ii) Eliminating interference between the concurrent dissolution of metal oxides and carbonate precipitation. (iii) Ensuring the complete recovery of all chemical species involved, particularly if additives are used. To address these challenges, continuously removing the leachate generated during the wet mineral carbonization reaction, treating this leachate, and recirculating the treated leachate to maintain continuous contact with the alkaline mineral has the potential to overcome these barriers in the wet mineral carbonization process.

The production of one ton of hydrogen (H₂) through the Steam Methane Reformer (SMR) process results in the generation of approximately 12 tons of CO₂. However, this produced CO₂ is not suitable for food and beverage (F&B) applications; it is mixed with other gases and requires additional electricity and thermal energy for further purification. The purification process involves cleaning and separating CO₂ from other gases, followed by drying it to meet F&B grade quality standards. Up to this point, the industry has typically found it more cost-effective to clean and dry the CO₂ to the level of industrial grade quality, primarily used in enhanced oil recovery (EOR) applications deep underground. This industrial grade quality CO₂ is not utilized in F&B industries.

Two significant issues remain unresolved in the Steam Methane Reformer (SMR) process. The first major concern is the emission of nearly 12 tons of CO₂ for every ton of hydrogen (H₂) produced, should the CO₂ not be captured. Globally, over 75 million tons of H₂ are manufactured using SMR, resulting in nearly 1 billion tons of CO₂ emissions each year. The second major issue is the extensive consumption of approximately 22 tons of water per ton of H₂, contributing to over 1.65 billion tons of water usage annually.

In comparison to SMR, electrolysis H₂ production process consumes 9 tons of water (H₂O)/ton H₂. Approximately 55 MWh of renewable electricity and 9 tons of purified H₂O/hour produces 1 ton/hour H₂ and 8 tons/hour O₂ during electrolysis. Combustion of 8 tons/hour O₂ with 2 tons/hour of methane (CH₄) in an electricity and heat generating combustion engine of 40% electricity generation efficiency would approximately produce 4.50 tons/hour of H₂O in vapor form, 5.50 tons/hour of CO₂, 10 MWh electricity, and 16 MWh heat. Due to pure oxygen combustion with cleaned natural gas (CH₄), the produced CO₂ and H₂O vapor are obviously much cleaner than that is produced in SMR process.

Scientists generally agree that the wet mineral carbonization process has the potential to permanently capture at least 0.20 tons of CO₂ per ton of alkaline mineral (AM). If all 5.50 tons per hour of cleaner CO₂ are directed through a wet mineral carbonization process, it is possible to permanently capture approximately 1.10 tons per hour of that CO₂. The IPCC has estimated the cost of this CO₂ capture to be in the range of $50 to $100 per ton, and such high costs have indeed posed challenges for current Carbon Capture, Utilization, and Storage (CCUS) projects.

If all the remaining 4.40 tons per hour of cleaner CO₂ are subjected to further purification, cooled to ambient temperature, and dried using a portion of the generated 10 MWh of electricity and 16 MWh of thermal energy, there is no need for additional energy input to produce food and beverage (F&B) grade CO₂ quality. Consequently, this integrated method for manufacturing F&B grade CO₂ without the need for additional energy can serve as a viable replacement for the current manufacturing processes that rely on additional energy. The primary cost associated with the current process of producing F&B grade CO₂ is attributed to energy consumption.

In the context of water conservation, if all 4.50 tons per hour of H2O in vapor form are efficiently recovered as condensate and reintroduced into the electrolysis process, the net water consumption for electrolysis can be significantly reduced to 4.50 tons of H2O per ton of H2 produced. Alternatively, this condensate can also be utilized in the mineral carbonization process, thereby transforming the entire integrated process into a “water-saving process” when compared to conventional electrolysis and/or mineral carbonization methods employed in the prior art.

A portion of the generated electricity and thermal energy can be utilized to facilitate the drying of the wet carbonated mineral produced by the wet mineral carbonization process. The surplus electricity can be supplied to the grid. This multifaceted product output approach will substantially contribute to reducing the overall cost associated with CO2 capture.

The integrated process method introduced here can harness green renewable electricity, derived from sources such as solar and wind, for electrolysis as the initial step. Consequently, the outset of this method can be categorized as ‘green’ or ‘carbon-neutral.’ However, the integration disclosed here takes it a step further, transforming it into a ‘carbon-negative’ process due to the compelling reasons outlined in [0015].

The invented integrated process method can:
1. use renewable energy during non-peak hours;
2. deliver multiple products and benefits such as green H2 of >99.99% purity from Electrolysis;
3. convert industrial AM waste into a valuable carbonated AM aggregate;
4. replace current manufacturing of F&B grade quality CO2 to save energy;
5. deliver electricity to the grid on demand during peak hours with Enhanced Frequency Response (EFR);
6. permanently capture significant quantity of CO2;
7. save significant quantity of water usage;
8. deliver an integrated decentralized carbon negative electricity generation, on demand system that will benefit the national grid and create significantly more employment opportunities in comparison to prior art electricity generation methods;
9. the system would overcome the current problems and costs related to: depleting resources of Lithium and its use in large electricity storage battery; ‘private wire’ connection between renewable energy generator and the consumer for electrolysis; transportation of H₂ to pump station, gas grid, and transportation of F&B grade CO₂ to the end users; and above all
10. A system of this nature can, for instance, employ prior art apparatus for mineral carbonization, as described in GB 2004019.2/PCT/EP2021/025106. This apparatus occupies a smaller land footprint while providing a larger surface area interface between gas, liquid, and solid components. This enhanced interface contributes to overall reaction efficiency improvement and cost reduction in mineral carbonization. Furthermore, it plays a pivotal role in creating a cost-effective environment free from air and water pollution. The positive impact of such a system extends significantly to the surrounding community in its vicinity and beyond, thereby fostering substantial social benefits.

The prior art apparatus and process method, exemplified by GB 2004019.2, effectively amalgamates the cleaning process for flue gas derived from industrial combustion with mineral carbonization. By integrating this prior art approach with the innovation presented in this invention, there is the potential to optimize the environmental advantages, sustainability, and overall feasibility of the entire integrated process for carbon-negative, on-demand electricity generation.

An important aspect of this invention focuses on water conservation in the mineral carbonization process by establishing continuous contact between a bed of alkaline minerals (AM) and a recirculated aqueous solution referred to as the ‘quenchant’ or for the purpose of greater clarity is referred to as ‘first solution’. To comprehend the novelty of this invention compared to prior wet mineral carbonization methods, it lies in maintaining a consistent gravity flow of the quenchant, which is kept at a particular temperature but has a lower pH than the AM, through a bed composed of AM particles. Simultaneously, the ‘leachate’ or the ‘second solution’ generated during the mineral carbonization reaction is continuously extracted from the bed. The resulting leachate has a higher pH than the quenchant. This extracted leachate is then treated and cooled. For greater clarity, this post-treated and cooled leachate is referred to as the reformed leachate or the treated “second solution”. The treated leachate solution is employed to quench the hotter gas containing CO₂ and water vapor, thus producing the quenchant with a specific temperature but a lower pH than that of the AM. The resulting leachate is then recirculated to maintain ongoing interaction with the bed of AM. Incorporating recirculated quenchant into the AM bed can also be executed using the method and apparatus outlined in GB 2004019.2. In this prior art approach, the recirculated quenchant is uniformly dispersed and allowed to flow by gravity across the entire surface area of the moving AM bed, effectively permeating the entire bed as it moves. The prior art encompasses multiple reactors, each containing a moving AM bed, with the quenchant evenly distributed among all the reactors. The leachate generated in this process is collected in a reservoir located beneath each moving AM bed. In this invention, such collected leachate undergoes treatment and is subsequently recirculated. The treatment of this leachate to maintain a consistent pH and temperature after quenching with hot gas, before the resulting quenchant, with a uniform temperature and pH, is recirculated back to the prior art, forms an integral part of the novelty of this invention. Additionally, the method of uniformly and equitably distributing this resulting quenchant into the multiple AM beds, for instance, as found in the multiple mineral carbonization reactors, each housing a moving bed of AM, as described in the prior art GB 2004019.2, is also a key aspect of the innovation introduced by this invention.

Another noteworthy innovation lies in the cooling and retrieval of condensate from the hot, moist gas discharged from a source. This is achieved by quenching the hot, moist gas with a coolant, which can be the treated leachate solution, water, or a water-based solution.

Yet another significant innovation pertains to the cooling of the leachate extracted from the prior art, which can experience an increase in temperature due to the exothermic reaction. This leachate is subjected to treatment, which may include the addition of additives and/or catalysts if deemed necessary. Furthermore, the leachate is treated to eliminate any of its constituents, and its pH is adjusted if required. Subsequently, this treated leachate is employed as a coolant to quench the moist, hot gas. Following this process, the resulting quenchant, characterized by a constant pH and temperature, resumes interaction with the static AM bed or the moving AM bed, as seen in the prior art GB 2004019.2, either at atmospheric pressure or above atmospheric pressure, in a continuous flow. This method holds the potential to enhance the extraction of metal oxides, as the leachate with a higher pH is rapidly removed from the AM bed upon production and replaced with the quenchant possessing a lower pH. The treatment applied to the leachate in each circulation, the maintenance of a consistent temperature in the resulting quenchant (higher than ambient temperature), and the maintenance of the lowest possible pH in the resulting quenchant (lower than that of the AM and the resulting leachate) collectively contribute to augmenting the mineral carbonization reaction, whether conducted at atmospheric pressure or above atmospheric pressure.

Another facet of this invention focuses on water conservation by avoiding direct quenching of a hot, moist gas or flue gas with a cooler post-treated leachate solution, water, or a water-based solution within an insulated enclosure until the resulting gas or flue gas reaches its dewpoint temperature. Once the dewpoint temperature is attained in the post-quenched gas or flue gas, it is then directed for a cleaning and drying process. This can be accomplished by either passing it through a prior art mineral carbonization reactor apparatus, such as the one described in GB 2004019.2, or sending it directly through the cleaning and drying process integrated within the system. Routing the gas via an apparatus like GB 2004019.2 serves to enhance the reaction rate of mineral carbonization and contributes to the cleaning and drying of CO2. Both the post-quenched resulting quenchant and the gas, which have reached the dewpoint temperature of the pre-quenched hot, moist gas, can be reheated to a temperature greater than the dewpoint before they interact within a reactor, similar to the one in GB 2004019.2. Gradually increasing the temperature of the resulting quenchant and gas boosts the reaction rate within GB 2004019.2. By matching the temperatures of the heated quenchant and gas sent to the reactor, such as in GB 2004019.2, it's possible to achieve nearly uniform temperatures within each of the insulated reactors in GB 2004019.2. This allows for extended residence time of gas interaction with the quenchant, which is advantageous for gas purification and improving the reaction rate. To achieve this, a portion of the hot, moist flue gas exiting the source is diverted to a heat exchanger to heat the quenchant, while another portion is redirected to mix with the post-quenched, cooler gas to raise its temperature. The condensate recovered from various methods of cooling the hot, moist gas exiting the source within the integrated system contributes to an increased liquid volume within the circulation. Excess liquid is removed from the circulation and directed to a reservoir within the integrated system for other purposes.

Another crucial aspect of this invention is enhancing energy recovery within the quenchant by quenching pre-quenched hot gas or hot flue gas with the pre-quenched treated leachate solution, water, or a water-based solution within an insulated enclosure. This process is carried out to achieve an equilibrium temperature between the resulting gas and the resulting quenchant. Alternatively, quenching can be performed to reduce the temperature of the resulting post-quenched gas to a level lower than the temperature of the pre-quenched gas, while simultaneously increasing the temperature of the quenchant to a level greater than the temperature of the pre-quenched treated leachate solution, water, or water-based solution during the quenching process.

Yet another aspect of the invention is to quench flue gas exiting from an O₂+CH₄ or air+O₂+CH₄ or O₂+CH₄+hydrogen or O₂+hydrogen or their combination with fossil fuel and bio-fuel run combustion engine with pre-quenched treated leachate solution or water or water solution thereof within an enclosure. The O₂ applied for combustion in the combustion engine is produced from an electrolysis process during non-peak electricity consumption hours. Also, such electrolysis process applies only renewable electricity to split H₂O into H₂ and O₂ which are stored for use in combustion engine when there is demand for EFR (Enhanced Frequency Response and/or Equivalent Forced Outage Rate) and for the electricity during peak hours. Consequentially, the condensate recovered from the hot H₂O vapor contained in the flue gas during quenching will increase the liquid volume in the circulation. Such excess liquid is removed from the circulation to a reservoir for other uses.

Yet another aspect of the invention is to supply the O₂ produced as in para [0022] and stored to a co-generation combustion engine that produces heat, electricity, CO₂, and H₂O vapor.

Yet another aspect of the invention is to apply a part of the heat, electricity, CO₂, and H₂O vapor generated as in para [0023] to a mineral carbonization process to permanently capture some part of that CO₂ in the AM.

Yet another aspect of the invention is to apply a part of the heat, electricity, CO₂, and H₂O vapor generated as in para [0023] to the process of further cleaning, reducing the temperature, and drying the remaining of that CO₂ after mineral carbonization process to produce F&B grade compatible quality.

Yet another aspect of the invention is to supply the remaining excess generated electricity after the production to the mineral carbonization process as in para [0024] and the production of F&B grade CO₂ as in para [0025] to the grid or directly to an end use.

Yet another aspect of the invention is to supply the H₂ that is produced and stored as in para [0022] to a combustion engine, H₂ fuel pump station, gas grid, and other end users.

Yet another aspect of the invention is to apply a part of the electricity and heat generated as in para [0023] to dry the wet carbonated mineral that is produced from the wet mineral carbonization process as in para [0024].

Yet another aspect of the invention is to integrate the process as described from para to [0028].

Yet another aspect of the invention is to apply water recovered from condensate in the integrated process as in para [0029] for the mineral carbonization process, and any remaining to the electrolysis process in the integrated process as in para [0029].

Yet another aspect of the invention is to collect all the recovered condensate from the integrated process as in para [0029] in a rain water reservoir and supply to the integrated process as in para [0029] from the rain water reservoir.

Yet another aspect of the invention is to carbonate all types of AM that will and that has the potential to capture and permanently sequester CO₂ and apply such carbonated/weathered AM for sustainable construction and industrial uses, such as sustainable aggregates in road and building construction, sustainable cement filler for an example to mix with Portland cement, as sustainable water treatment constituent for an example to remove heavy metals such as Cadmium (Cd) contained in the water, as sustainable soil conditioner and other industrial applications thereof.

Yet another aspect of the invention is to reduce the carbon footprint in the production of F&B grade CO₂ quality without using additional energy other than that generated in the integrated process as in [0029] and substitute the current production of F&B CO₂ quality that uses additional energy.

### DESCRIPTION OF THE DRAWING

FIG. 1: is the flow diagram of integrated processes to save water during novel mineral carbonization, improve heat recovery from flue gas, for example, flue gas exiting a O₂+CH₄ combustion engine which produces H₂O vapor, CO₂, electricity, and heat wherein (001) is such combustion engine. The hot moist flue gas from (001) is sent via an insulated duct (not shown in the drawing) to an insulated enclosure (002). The cooler treated leachate solution is sent from (004) to the insulated enclosure (002) to quench the hotter flue gas inside insulated enclosure (002). Duct and pipe (not shown in the drawing) separately carrying the resulting flue gas and resulting quenchant from (002) to the mineral carbonization reactor, herein referred to as ‘reactor’(003) are insulated. The quenching as in (002) can be combined and done within the reactor (003) if it is possible to save more energy and water than the former arrangement that separates insulated enclosure (002) and reactor (003).

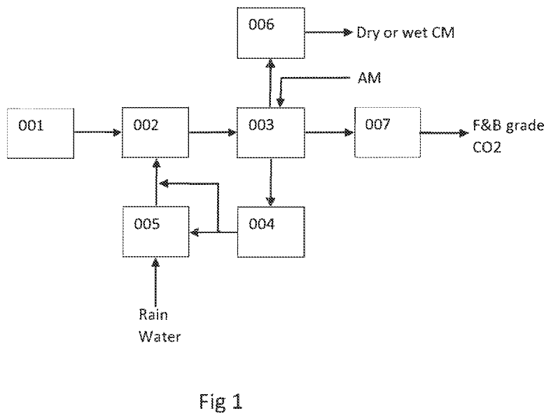

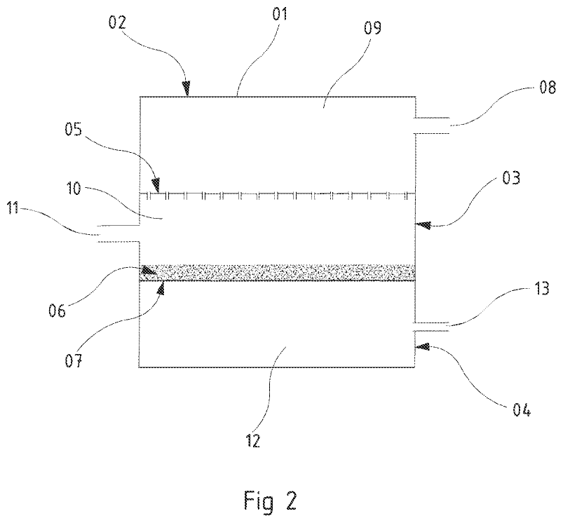

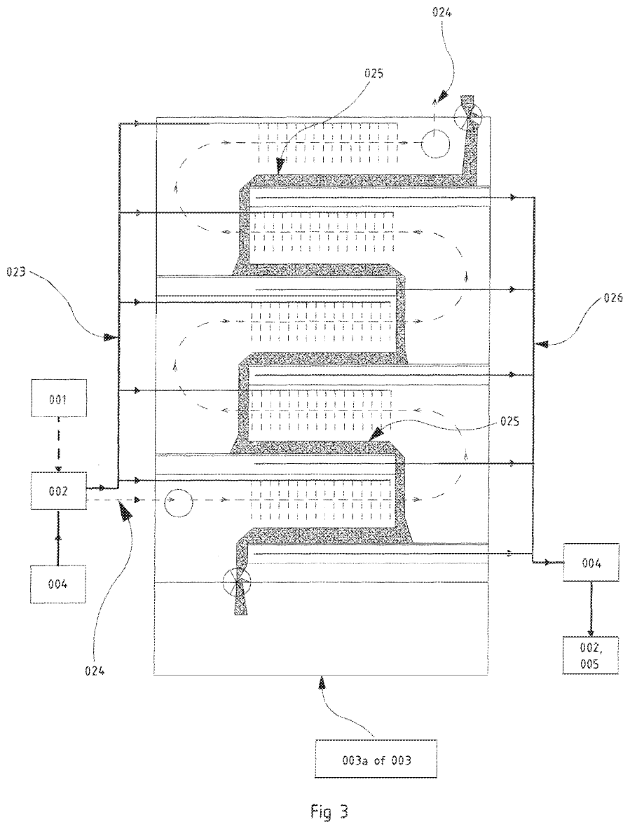

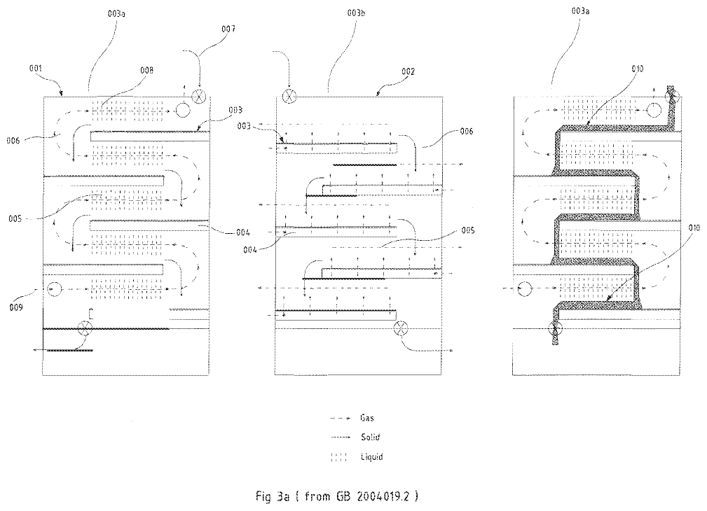

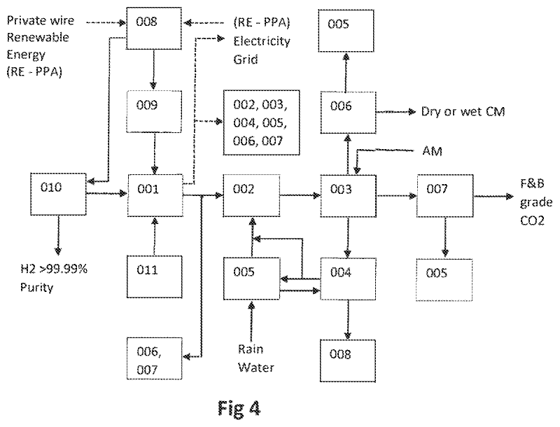

An aspect of the invention is to add additives and catalyst to the treated leachate solution in (004).

Another aspect of the invention is to add additives and catalyst to the resulting quenchant in the insulated enclosure (002).

The resulting quenchant or both the resulting quenchant and the resulting gas in (002) are sent to a reactor (003) for an example such as in GB2004019.2 wherein mineral carbonization reaction occur. Such reactor (003) body is insulated to save energy. The resulting gas in (002) is either sent to the reactor (003) via an insulated duct or to (007) via insulated duct (not shown). The resulting quenchant is pumped into reactor (003) via an insulated pipe. The CO₂ capturing and permanently sequestering AM, herein referred to as ‘AM’, is shown fed into the reactor (003).

The resulting gas if sent to reactor (003), more particularly to the reactor such as in GB 2004019.2 containing plurality reactors (003), is mixed (not shown) with a part of the hotter moist gas received directly from (001) into the reactor (003). Then the mixed heated gas interface with sprayed and distributed quenchant inside the reactor as shown in FIG. 3 and FIG. 3a. The sprayed and distributed quenchant continuously interface with the AM bed contained inside each of those reactors (003).

A part of the hotter moist gas from (001) can be sent to a heat exchanger (not shown) to heat the quenchant before it is sent to the reactor (003). The cooler gas exiting such heat exchanger (not shown) is either sent to the reactor (003) or to (007). The condensate if any recovered from such heat exchanger (not shown) is sent to rain water reservoir (005). The leachate produced from the reaction occurring inside the reactor (003) is removed from reactor (003) and is sent for treatment in (004). The treated leachate solution in (004) is recirculated back to insulated enclosure (002).

The water vapor contained in the moist hotter flue gas exiting from combustion engine (001) is cooled and condensed inside the insulated enclosure (002) during quenching with cooler treated leachate solution, water, or water solution thereof. For greater clarity, this recovered water is referred to as ‘third solution’. The temperature of the moist hotter flue gas can be reduced to its 5 dewpoint temperature. The condensation due to cooling increases the liquid volume in the circulation. Also, the cooling reduces the volume of the resulting flue gas compared to the volume of the pre-quenched hotter moist flue gas exiting the combustion engine (001). The excess liquid if any after mineral carbonization in the reactor (003) and after treatment in (004) is removed from the continuous circulation between (002), (003), (004), and is stored in the rainwater reservoir (005) for other uses.

Insulation to the connecting ducts and pipes between combustion engine (001), enclosure (002), reactor (003), (007), and the insulated heat exchanger (not shown); insulated enclosure (002); insulated reactor (003); and the method of quenching until the temperature of the moist hotter flue gas reaches its ≤dewpoint or quenching until an equilibrium temperature is reached between the resulting gas and the resulting quenchant or quenching to reduce the temperature of the hotter moist flue gas inside the insulated enclosure (002) will altogether contribute to reduce the loss of thermal energy into the atmosphere and potentially increase the energy efficiency of the heat recovery from the hotter moist flue gas exiting the combustion engine (001) which is transferred to the resulting quenchant.

The temperature and volume flow of the hot flue gas into the insulated enclosure (002); temperature and volume flow of treated leachate solution from (004) into the insulated enclosure (002); the inside volume and configuration of the insulated enclosure (002); and the surface area interface between the treated leachate solution and the hot flue gas inside the insulated enclosure (002) will determine the time taken to reach an equilibrium temperature between the resulting flue gas and the resulting quenchant inside the insulated enclosure (002).

The flue gas resulting from quenching in insulated enclosure (002), cooler flue gas exiting the heat exchanger (not shown), and the hotter moist flue gas that is mixed with cooler flue gas would contain mixture of clean CO₂ and clean water vapor because of combustion of pure O₂ with CH₄ preferably cleaned. To save energy, such mixture of hotter and cooler CO₂ gas and the remaining water vapor can be further cleaned, cooled, and the CO₂ is partially dried during wet mineral carbonization in the prior art reactor (003) for an example as in GB 2004019.2, before it is sent to further cleaning, cooling and drying process in (007) wherein it is made compatible as F&B grade quality before sending it to a storage from (007). The dryer within (007) is preferably a condensing dryer to potentially recover condensate. The recovered condensate if any is sent to the rainwater reservoir (005) for storage and use.

The processed wet AM is sent from the reactor (003) to preferably a condensing dryer (006) wherein the wet AM received from the reactor (003) is dried the condensate is recovered. The recovered condensate is sent to the rainwater reservoir (005) for storage and use.

A part of electricity generated in combustion engine (001) is used in (002), (003), (004), (005), (006), (007) and in the heat exchanger (not shown). The heat (thermal energy) in the form of flue gas exiting combustion engine (001) is used in (002), (003), (006), (007) and in the heat exchanger (not shown). Remaining electricity generated in combustion engine (001) is supplied to the grid.

The O₂ required for combustion in the combustion engine (001) is produced in an electrolysis process (not shown) which only uses renewable electricity to split water or the ‘third solution’ into H₂ and O₂. Such produced O₂ is stored (not shown) and is delivered on demand to the combustion engine (001). The clean CH₄ required for combustion in the combustion engine (001) is outsourced. Such outsourced CH₄ is delivered on demand to the combustion engine (001) either from a storage or directly from the natural gas grid network.

The renewable electricity required for electrolysis is either received via a private wire connection or from the electricity grid network (not shown) under a Power Purchase Agreement (PPA). This is received during non-peak electricity consumption hours or is received in lesser quantity during the peak electricity consumption hours. Preferably, the combustion engine (001) either produces electricity during the peak hours and delivers for EFR (Enhanced Frequency Response and/or Equivalent Forced Outage Rate) to the electricity grid when needed or produces more electricity during the peak hours and delivers EFR when needed to the electricity grid.

The electricity and H₂ produced in the integrated process can be termed ‘carbon negative’ because it replaces the current production of F&B grade quality CO₂ that uses carbon intensive electricity and heat. Thus, the full end use of such F&B grade quality CO₂ makes the combustion process ‘carbon neutral’. The production of low-cost F&B grade quality CO₂ will immensely benefit emerging CCU projects and technologies using F&B grade clean CO₂ as feed stock rather than using industrial grade CO₂ of similar cost as feed stock. For an example, the low-cost F&B grade clean CO₂ will immensely benefit the technology that converts CO₂ into electricity and H₂.

The capture and permanent sequestration of some part of CO₂ produced in (001) in the novel mineral carbonization process, makes the entire integrated on demand decentralized electricity generation a ‘carbon negative’ process. Since renewable electricity is used in the production of H₂ and O₂ in electrolysis, the produced H₂ can be termed ‘green H₂’. Using the produced and stored pure O₂ to generate electricity on demand contributes to make the integrated electricity generation ‘carbon negative’. Furthermore, the theoretical and technical evaluation of CO₂ reduction in comparison to the SMR process demonstrates prevention of almost 12 tons of CO₂ emission from producing 1 ton of H₂. Thus, this integrated process can become ‘carbon negative’ and deliver greater benefits than the standalone capture and permanent sequestration of CO₂ in the novel wet mineral carbonization process. It is estimated that a 1 ton of H₂ production in the integrated process will have to deal with capturing only 5.5 tons of CO₂ in comparison to SMR process that has to deal with capturing almost 12 tons CO₂ per 1 ton of produced H₂.

The total H₂ produced per hour in electrolysis should meet the local demand i.e., the demand within the closer proximity to the integrated plant site producing green hydrogen, carbon negative electricity, F&B grade quality CO2, and processed AM. Thus, delivering a decentralized carbon negative electricity generation on demand with other outputs meeting the demand for all such outputs within a specific designated area. The remaining H₂ is combusted with O₂ and/or air to produce electricity, heat, and H₂O. The processed AM aggregates produced in such decentralized carbon negative energy generation system can be applied in building, road construction, road surfacing, road repairs, water treatment etc., within that designated area. It makes it possible to supply hot and dry processed AM aggregate output to mix with bitumen (asphalt) and transport to the site for application for example in road surfacing and road pot hole repairs. This will save energy and reduce air pollution caused by those processes.

In the reactor (003) the prior art method for example as in GB 2004019.2 allows the received quenchant to pass through the bed of AM which becomes a leachate solution after passing though the bed of AM. The delta pH between the quenchant and leachate decrease with the increase in the duration of the mineral carbonization reaction whilst the quenchant pH and temperature are constant.

An aspect of the invention is to constantly maintain the pH of the quenchant sent to the reactor (003) at lower pH compared to the leachate pH when the mineral carbonization reaction begins. The leachate pH would be higher at the beginning of the reaction due to AM's higher alkalinity. The leachate pH will gradually lower as the mineral carbonization process progress whilst a constant pH and temperature is maintained in the quenchant.

Another aspect of the invention is to heat and maintain the temperature of the quenchant exiting the insulated enclosure (002) between ≥90° C. to <100° C. This may prevent or reduce flashing of the dissolved CO₂ from the quenchant which can occur at >100° C. (boiling point of water). Thus, lower pH in the quenchant liquid solution can be maintained to improve the reaction efficiency in the mineral carbonization process. Any incremental increase in the temperature of the quenchant (that measures lowest achievable pH at the dewpoint temperature of the pre-quenched moist hot gas) from such dewpoint temperature and up to <100° C. will potentially increase the mineral carbonization reaction rate at atmosphere pressure or above atmosphere pressure.

Yet another aspect of the invention is to maintain greater value of delta pH between the quenchant and the leachate to increase the mineral carbonization reaction rate in the reactor (003).

Yet another aspect of the invention is to maintain ≤4 pH in the quenchant and ≥5 pH in the leachate or maintain in the quenchant <0.1 pH value than the leachate pH value during the mineral carbonization process.

Yet another aspect of the invention is to continuously replace the leachate with the quenchant in the AM bed contained in the reactor (003).

Yet another aspect of the invention is to maintain a constant temperature and pH in the treated leachate solution before sending treated leachate solution from treatment (004) to the insulated enclosure (002).

Yet another aspect of the invention is to carbonate the leachate under pressure in the treatment (004) to reduce the treated leachate solution pH during the treatment (004).

Yet another aspect of the invention is to apply a part of the F&B quality CO₂ produced in the integrated process to carbonate the leachate during the treatment (004).

Yet another aspect of the invention is to continuously maintain a constant temperature and pH in the quenchant before sending it to the reactor (003).

The following are the results from an experiment conducted to prove the novel wet mineral carbonization process at atmosphere pressure.

### Materials and Method:

1. Simulating the condition of continuously receiving into the reactor (003) the quenchant and flue gas resulting from quenching, as in quenching inside the insulated enclosure (002). For this purpose, the hotter moist flue gas continuously exiting a combustion engine is quenched with the cooler water of 7 pH as in quenching inside the insulated enclosure (002) which is coupled to;
2. an apparatus simulating the mineral carbonization reaction conditions inside the reactor (003) after continuously receiving quenchant of a constant temperature of around 40° C. and 3 pH from the insulated enclosure (002).
3. To start the process, instead of applying cooler treated leachate solution (which was not available at the beginning of the experiment) ambient water (8° C.) of neutral 7 pH quenched the hotter moist flue gas of average 120° C. to continuously produce and deliver a resulting 40° C. and 3 pH quenchant into the apparatus. Despite heat losses due to uninsulated duct that carried the flue gas, the resulting quenchant temperature was 40° C. and the resulting flue gas temperature exiting the apparatus was 50° C. In this case study, only the quenchant was interfaced with the bed of AM contained in the apparatus as in AM bed contained within the reactor (003). The resulting flue gas was let out to the atmosphere. The leachate pH measured 6.6 pH at the beginning of the process and leachate temperature measured 34° C.
4. The AM used in the experiment was 2000 grams (2 kgs) calcined dolomite granules of standard composition, 2 mm to 5 mm particle size, and 1.6% moisture content. The quenchant was continuously interfaced with the static bed of such AM.
5. During the 1 hour process the continuous flow of quenchant was constantly maintained at around 3 pH and 40° C. The leachate pH dropped from 6.6 pH measured at the beginning of the process to 6.5 pH at the end of 1 hour. The temperature of the leachate was constant at around 34° C. throughout the process.
6. After 1 hour process, the wet calcined dolomite granulates was dried to 1.5% moisture content and weighed. The weight measured 2,184 grams indicating a 184 grams net increase in weight. This corresponded to an increase of 9.2% weight/1000 grams calcined dolomite.

### Conclusion:

Controlling the process of mineral carbonization and determination of process being completed are possible under atmosphere pressure by measuring the leachate pH at a constant temperature whilst the quenchant pH and the temperature are kept constant. The drop in pH from 6.6 to 6.5 in an hour demonstrated that the mineral carbonization reaction in the AM bed was constant and consistent throughout one hour. Maintaining constant 40° C. and 3 pH in quenchant achieved a CO₂ capture and permanent sequestration by the weight increase of 9.2% in an hour. Further increasing the temperature of the quenchant at 3 pH and extending the process duration has the potential to increase the rate of CO₂ capture and permanent by weight increase at atmospheric pressure. Most types of AM including steel slag, fly ash etc., industrial wastes can be used for mineral carbonization in this invented mineral carbonization method. Particle size smaller than the 2 mm to 5 mm size range has the potential to increase the rate of CO₂ capture and permanent sequestration due to increase in the surface area.

Benefits from Weathering Steel Slag Waste:

Such experiment has established the feasibility of CO₂ capture in steels lag. As the steel slag is calcined at higher temperature (1500° C.) in comparison to calcined dolomite (900° C.) that was used in the experiment, the duration to achieve similar results in the former may take longer than in the latter. Nevertheless, it would establish the fact that the conventional open-air watering and windrowing method applied to weather/mineral carbonization of the steel slag which normally takes 90 days of processing can be potentially reduced to few hours. Thus, significantly reducing the cost of such weathering. The air pollution caused by open-air weathering is prevented when it is done within an enclosure such as in the prior art GB 2004019.2. The water pollution is prevented due to the recirculation of treated leachate solution such as in this invention. Potentially, significant quantity of water usage can be reduced. Potentially, a higher quality weathered steel slag can be produced from the steel slag waste.

FIG. 2: is the cross section of the apparatus used in the experiment which comprise (01), (02), and (03) sections that are assembled together and the entire assembled body is insulated to reduce the heat loss to the outside atmosphere.

In the section (01), the mixture (09) of resulting quenchant (10) and resulting flue gas (10) is continuously received into the apparatus via (08) from an insulated enclosure (002) that is not shown in the drawing. The distributor (05) distributes the forced downward draft of the mixture (09) of the resulting flue gas (11) and the gravitational flow of the resulting quenchant (10) sprayed uniformly across the entire cross section area inside the apparatus. The temperature of the quenchant is constantly maintained at around 40° C. and 3 pH.

In the section (2), the resulting flue gas (11) is allowed to escape into the atmosphere in this experiment. However, in industrial application it is converted into F&B grade quality CO₂.

In the section (2), the uniformly distributed quenchant fall by gravity onto the entire surface area of the static AM bed (06). The spread quenchant flows by gravity through the AM bed (06) to the bottom of the AM bed (06), and through a perforated floor (07).

In the section (3), the leachate produced from the exothermic mineral carbonization reaction occurring in the static AM bed (06) and coming through the perforated floor (07) of section (2) is collected in the reservoir (12). The leachate is removed from the reservoir (12) via (13).

FIG. 3 and FIG. 3a: These are schematic illustrating the method of distributing resulting flue gas (024) and the resulting quenchant (023) exiting the insulated enclosure (002) to the plurality mineral carbonization reactors in the flue gas and quenchant receiving first tower (003a) of the prior art GB 2004019.2. Not shown in the drawing is the heating of the resulting quenchant and gas before it enters the first tower (003a). The heated quenchant is shown equally distributed to all the reactors in the first tower. Such heated quenchant is sprayed and the quenchant droplets fall by gravity across the entire surface area of the moving AM bed (025) in each of those reactors. The heated gas sent from the bottom most reactor interface with the falling droplets of the heated quenchant as it flows upwards through all the reactors to exit from the top most reactor. As the temperature of heated quenchant is maintained similar to the temperature of the heated gas entering the bottom most reactor, almost similar temperature is maintained within the moving AM bed in all those reactors. The leachate (026) collected from each of those reactors is sent to treatment (004). The prior art GB 2004019.2 contain plurality of insulated mineral carbonization reactors containing moving AM bed (025) in the first tower (003a) shown in FIG. 3, and in the second tower (003b) shown in the FIG. 3a. According to the prior art method in GB 2004019.2, the quenchant (023) is spread by gravity flow uniformly across the entire surface area of the moving AM bed (025) in reactors only in the first tower (003a) and not in the reactors in the second tower (003b). A reference drawing of the first (003a) tower and the second (003b) tower from GB 2004019.2 is shown in the FIG. 3a. Therefore, in the invented method the heated quenchant is equally distributed only to those reactors in the first tower (003a). The leachate (026) collected from each of those reactors is sent to treatment (004).

Calculating thermal energy recovery efficiency from the hotter moist flue gas exiting the combustion engine (001) in the invented method is straight forward. Only the heat loss to the atmosphere despite the insulation will determine the efficiency of the heat recovery from the flue gas. Due to insulation, there is a potential to reduce such heat loss to bear minimal. It is estimated that a recovery of >70% of the thermal energy contained in the flue gas for use in the integrated process is possible.

FIG. 4: Is a schematic cross section of a prior art reactor (003) shown integrated with the invented integrated process wherein; all of the thermal energy (heat) generated in the combustion engine (001) is distributed for consumption in (002), (003), (006),(007) and heat exchanger that is not shown; a part of electricity generated in combustion engine (001) is distributed for consumption in (002), (003), (004), (005), (006), (007) and in the heat exchanger that is not shown; the remaining electricity is supplied to the grid; the condensate recovered or the ‘third solution’ from (002), (003), (006), (007) and in the heat exchanger (not shown) is sent to storage in rain water reservoir (005).

Renewable energy is supplied to an electrolysis process (008) to split pure H₂O received from the rainwater reservoir (005) after treatment in (004). This produces and stores pure O₂ (009) and pure H₂ of >99.99% purity (010).

Outsourced and stored clean CH₄ (011), and pure O₂ (009) is supplied on demand to the combustion engine (001) to produce H₂O in vapor form, CO₂, heat, and electricity.

An aspect of the invention is that the outsourced clean fossil fuel and/or clean bio fuel or a mixture of clean fossil and clean bio fuel (not shown in the drawing) and pure O₂ (009) is supplied on demand to the combustion engine (001) to produce H₂O in vapor form, CO₂, heat, and electricity.

Another aspect of the invention is to supply pure and green H₂ (010) to meet the demand in the nearby H₂ pump station, gas grid, and other uses.

Yet another aspect of the invention is to supply pure and green H₂ (010) to the combustion engine (001).

Yet another aspect of the invention is to supply pure and green H₂ (010) to a second combustion engine that uses only O₂ or Air or a mixture of both for combustion with pure and green H₂ (not shown in the drawing). The produced electricity, H₂O vapor and heat are added to the output of the first combustion engine (001) but not with the CO₂ produced in the first combustion engine (001). The outputs are distributed for consumption and application as shown in the integrated process in FIG. 4.

Yet another aspect of the invention is to prevent air pollution in the integrated decentralized carbon negative electricity generation on demand process by supplying all the produced F&B grade quality CO₂ to be consumed by end users and CCUS projects and thus replace the current production of F&B grade quality CO2 that use carbon intensive energy to reduce the global CO₂ foot print.

Another significant aspect of this invention is the mitigation of water pollution through the treatment of all recovered water or the ‘third solution’ within the integrated decentralized carbon-negative electricity generation process, available on-demand for consumption within the process. This approach contributes to reducing the global fresh water footprint.

1. A method for wet mineral carbonation comprising;
1. quenching hotter gas with the cooler treated leachate solution;
2. continuously interface the resulting quenchant as in (1) with a bed of CO2 capturing alkaline mineral;
3. continuously maintaining a lower pH value in the resulting quenchant as in (1) in comparison to the leachate produced and collected at the bottom of the bed during the mineral carbonation reaction as in (2);
4. removing the collected leachate as in (2) for treatment; and
5. recirculating such treated leachate solution as in (4) to quench the hotter gas as in (1).

2. The method of claim 1 further comprising;
uniformly distributing the resulting quenchant from step 1 and step 3 of claim 1 to interface with plurality bed of CO2 capturing alkaline mineral and removing the collected leachate from the bottom of each bed as in step 3 and step 4 in the claim 1.

3. The method of claim 1 further comprising;
continuously interface the resulting gas from the step 1 of the claim 1 with a bed of CO2 capturing alkaline mineral.

4. The method of claim 2 further comprising;
continuously interface the resulting gas from the step 1 of the claim 1 with plurality bed of CO2 capturing alkaline mineral.

5. The method of wet mineral carbonation of claim 1 or claim 2 or claim 3 or claim 4 integrated to the process of producing green hydrogen, food and beverage grade quality carbon dioxide, electricity on demand, and carbonated mineral aggregates comprising:
1. producing green hydrogen and oxygen in an electrolysis process applying only renewable electricity to split water into hydrogen and oxygen;
2. storing the produced green hydrogen and oxygen from (1) for consumption;
3. combusting the oxygen from (2) with fuel to produce water vapor, carbon dioxide, heat and electricity on demand;
4. sending such produced water vapor, carbon dioxide, and heat resulting from (3) to quenching as in the step 1 of claim 1;
5. applying a part of produced electricity from (3) to the wet mineral carbonation method as in claim 1 or claim 2 or claim 3 or claim 4 to produce wet carbonated mineral and permanently capture some part of the carbon dioxide that is produced from combustion as in (3);
6. applying a part of produced electricity from (3) to convert the remaining of the carbon dioxide after capture in the wet mineral carbonation as in (5) into a food and beverage grade quality carbon dioxide;
7. applying a part of the produced heat from (3) for drying carbon dioxide that is required for the production of food and beverage grade quality carbon dioxide; and
8. supplying the remaining produced electricity to the grid.

6. The method of claim 5 further comprising;
1. applying a part of produced electricity in the step (3) of claim 5 to dry the produced wet carbonated mineral produced in the step (5) of the claim 5;
2. applying a part of the produced heat in the step (3) of claim 5 to dry the produced wet carbonated mineral produced as in the step (5) of the claim 5; and
3. supplying the remaining produced electricity to the grid.

7. The method of claim 1 or claim 2 or claim 3 or claim 4 further comprising;
heating and increasing the temperature of the quenchant resulting from the step 1 of the claim 1 to achieve a temperature between ≥dew point temperature of the hotter gas as in step 1 of the claim 1 and <100° C.
